(19) United States
(12) Patent Application Publication
(10) Pub. No.: US 2019/0066348 A1
(43) Pub. Date: Feb. 28, 2019

(54) IMAGE PROCESSING SYSTEM AND METHOD

(71) Applicant: WOW HOW LTD., West Midlands (GB)

(72) Inventors: Paul JENNINGS, West Midlands (GB); Gaynor MATTHEWS, West Midlands (GB)

(21) Appl. No.: 16/080,539

(22) PCT Filed: Feb. 28, 2017
(86) PCT No.: PCT/EP2017/054664

§ 371 Date: Aug. 28, 2018

(30) Foreign Application Priority Data
Feb. 29, 2016 (GB) 1603495.1
Dec. 7, 2016 (GB) 1620819.1

(51) Int. Cl. G06T 11/60; A45D 44/00; G06K 9/00

(52) U.S. Cl. CPC G06T 11/60; A45D 44/005; G06T 2207/20221; A45D 2044/007; G06K 9/00248

(57) ABSTRACT

The present invention provides a computer-implemented method of processing an image of a user. The method comprises: storing an anatomical features database comprising information on at least one category of anatomical features in a computer-readable memory, wherein each category of anatomical features includes a number of anatomical feature types; receiving first image data of a user, the first image data representing anatomical features of the user; processing the received first image data to isolate anatomical feature elements of the user from within the first image data; comparing the isolated anatomical feature elements with information in the anatomical features database to determine the user's anatomical feature type within each category of anatomical features; storing a representation of the user as second image data in a computer-readable memory; storing an instructions database comprising a plurality of image processing instructions in a computer-readable memory, each image processing instruction corresponding to one of the said anatomical feature types; image processing the second image data by carrying out a said image processing instruction corresponding to the user's determined anatomical feature type for a first category of the categories of anatomical features; and displaying the image processed second image data.

### RELATED APPLICATIONS

The present application is a national stage application under 35 U.S.C. § 371 of International Application No. PCT/EP2017/054664, filed 28 Feb. 2017, which claims priority to Great Britain Patent Application No. 1620819.1, filed 7 Dec. 2016, and Great Britain Patent Application No. 1603495.1, filed 29 Feb. 2016. The above referenced applications are hereby incorporated by reference into the present application in their entirety.

### FIELD

The present invention relates to an image processing system and method, particular to an image processing system and method for providing tutorials to a user. The present invention also relates to a mobile device and associated method.

### BACKGROUND

There are a variety of conventional image processing systems available. It is known to take images of users of users and manipulate them. For example, an image of a user can be taken and various filters can be applied. Alternatively, additions such as graphics can be applied to an image.

### SUMMARY

It is an aim of the invention to provide an image processing apparatus and method that has a number of benefits when compared to conventional systems.

According to an aspect of the invention, there is provided a computer-implemented method of processing an image of a user, comprising: storing an anatomical features database comprising information on a plurality of categories of anatomical features in a computer-readable memory, wherein each category of anatomical features includes a number of anatomical feature types; receiving first image data of a user, the first image data representing anatomical features of the user; processing the received first image data to show a representation of a first anatomical feature type within a first category of anatomical features overlaid on the first image data, receiving a user input for scrolling between different anatomical feature types within the first category of anatomical features overlaid on the first image data, receiving a user selection relating to the user's choice of their anatomical feature type for the first category of anatomical features, and repeating this step for each of the other categories of anatomical features; storing a representation of the user as second image data in a computer-readable memory, wherein the second image data is obtained based on the user's choice of their anatomical feature type for each category of anatomical features; storing an instructions database comprising a plurality of image processing instructions in a computer-readable memory for each category of anatomical features, each image processing instruction corresponding to one of the said anatomical feature types; image processing the second image data by carrying out a said image processing instruction corresponding to the user's determined anatomical feature type for one of the categories of anatomical features, displaying the image processed second image data, and repeating this step for all the categories of anatomical features in a sequence. The method can be used to provide instruction information tailored to the user's anatomical features.

In some embodiments, the method can further comprise: processing the received first image data to isolate anatomical feature elements of the user from within the first image data; processing the received first image data to show the representations of the anatomical feature types within the categories of anatomical features overlaid on the first image data at respective positions corresponding to corresponding isolated anatomical feature elements of the user.

According to an aspect of the invention, there is provided a computer-implemented method of processing an image of a user, comprising: storing an anatomical features database comprising information on at least one category of anatomical features in a computer-readable memory, wherein each category of anatomical features includes a number of anatomical feature types; receiving first image data of a user, the first image data representing anatomical features of the user; processing the received first image data to isolate anatomical feature elements of the user from within the first image data; comparing the isolated anatomical feature elements with information in the anatomical features database to determine the user's anatomical feature type within each category of anatomical features; storing a representation of the user as second image data in a computer-readable memory; storing an instructions database comprising a plurality of image processing instructions in a computer-readable memory, each image processing instruction corresponding to one of the said anatomical feature types; image processing the second image data by carrying out a said image processing instruction corresponding to the user's determined anatomical feature type for a first category of the categories of anatomical features; and displaying the image processed second image data.

According to an aspect of the invention, there is provided a computer-implemented method of processing an image of a user, comprising: storing an anatomical features database comprising information on a plurality of categories of anatomical features in a computer-readable memory, wherein each category of anatomical features includes a number of anatomical feature types; receiving first image data of a user, the first image data representing anatomical features of the user; processing the received first image data to isolate anatomical feature elements of the user from within the first image data; comparing the isolated anatomical feature elements with information in the anatomical features database to determine the user's anatomical feature type within each category of anatomical features; storing a representation of the user as second image data in a computer-readable memory; storing an instructions database comprising a plurality of image processing instructions in a computer-readable memory, each image processing instruction corresponding to one of the said anatomical feature types; image processing the second image data by carrying out a said image processing instruction corresponding to the user's determined anatomical feature type for one of the categories of anatomical features, displaying the image processed second image data, and repeating this step for all the categories of anatomical features in a sequence.

Using such methods, image processing can be applied to an image of a user that is adapted to the particular anatomical features of the user. For example, the image of the user (e.g. first image data) may be of the user's face. The image processing done on the image of the user may provide image processing that is tailored to the user's face by applying different image processing instructions (i.e. image processing techniques) depending on what facial features the user has.

The image processing of the second image data can comprise carrying out series of image processing instructions that correspond to the user's determined anatomical feature type for one of the categories of anatomical features. For example, image processing instructions may represent tutorial steps that are tailored to the user's determined anatomical feature types.

In some embodiments, the method further comprises image processing the second image by carrying out the image processing instructions corresponding to the user's determined anatomical feature types for all the categories of anatomical features.

In some embodiments, the user's isolated anatomical feature elements are used to create an avatar of the user, and the second image data comprises a view of said avatar.

In some embodiments, the user's anatomical feature type for each category of anatomical features is used to create an avatar of the user, and the second image data comprises a view of said avatar.

In some embodiments, the second image data is displayed based on the first image data.

In some embodiments, the method further comprises storing a plurality of image transformations in the instructions database, each image transformation comprising a number of transformation steps, wherein each transformation step corresponds to one category of anatomical features and comprises a respective image processing instruction for each anatomical feature type within that category.

In some embodiments, the method further comprises receiving a selection of an image transformation; image processing the second image data according to a first transformation step of the selected image transformation by carrying out the image processing instruction of the first transformation step that corresponds to the user's determined anatomical feature type for the category of anatomical features corresponding to the first transformation step; and displaying the image processed second image data according to the first transformation step.

In some embodiments, the method further comprises image processing the second image data according to the other transformation steps of the selected image transformation in order; and displaying the image processed second image data for each transformation step.

In some embodiments, the method further comprises receiving a user selection to select a said transformation step, and displaying the image processed second image data according to the selected transformation step.

In some embodiments, the processing the received first image data to isolate anatomical feature elements of the user from within the first image data comprises: determining a plurality of control points within the first image data; and comparing relative locations of control points with stored anatomical information.

In some embodiments, the comparing the isolated anatomical feature elements with information in the anatomical features database to determine the user's anatomical feature type within each category of anatomical features comprises: for each isolated anatomical feature element, determining user's anatomical feature type in the anatomical features database that is the best match.

In some embodiments, each image processing instruction comprises a graphical effect to be applied to at least a portion of the second image data, wherein the graphical effect comprises at least one of a colouring effect or animation.

In some embodiments, the displaying of the image processed second image data provides tutorial information to the user. For example, the tutorial information may be beauty treatment tutorials, such as for makeup skin care and nails. As an example, makeup tutorial videos are popular on streaming video sites. A user would typically select a video and watch the performer apply makeup to his or her self. Such videos are, however, often hard to follow for users, particularly if the user is not skilled at makeup application. The same is true for beauty treatment tutorials, such as skin care and nails. Embodiments of the invention such as the one discussed above provide numerous advantages when compared to traditional tutorial videos. The tutorial of such embodiments of the invention is tailored to the anatomy of the user, which is a large benefit when compared to just being shown the tutorial with respect to a performer. Furthermore, the user may select a certain step or cycle through the steps as they wish, which is not possible with a conventional video.

In some embodiments, the anatomical features are facial features of the user, and wherein the processing of the received first image to isolate anatomical feature elements of the user comprises performing facial recognition.

In some embodiments, the anatomical features are hand and nail features of the user, and wherein the processing of the received first image to isolate anatomical feature elements of the user comprises performing hand and nail recognition.

In some embodiments, the method further comprises capturing video images of the user; and displaying the image processed second image data alongside the captured video images of the user.

In some embodiments, the method further comprises displaying captured video images of the user in a mirror window in a first region of a touch screen display, and simultaneously displaying the image processed second image data in an application window in a second region of the touch screen display; receiving a user interaction from the touch screen indicating a directionality between the first region and the second region; wherein if the directionality represents a direction from the first region to the second region, the method comprises increasing the size of the mirror window and decreasing the size of the application window; and wherein if the directionality represents a direction from the second region to the first region, the method comprises increasing the size of the application window and decreasing the size of the mirror window. In some such embodiments, the method comprises displaying the mirror window in a full screen mode, and receiving a user interaction from the touch screen indicating a directionality representing a direction from the second region to the first region, and decreasing the size of the mirror window and showing the application window. In some such embodiments, the method comprises displaying the application window in a full screen mode, and receiving a user interaction from the touch screen indicating a directionality representing a direction from the first region to the second region, and decreasing the size of the application window and showing the mirror window.

According to an aspect of the invention, there is provided a computer readable medium carrying computer readable code for controlling an image processing system to carry out the method of any one of the above mentioned embodiments.

According to an aspect of the invention, there is provided an image processing system for processing an image of a user, comprising: an anatomical features database comprising information on at least one category of anatomical features, wherein each category of anatomical features includes a number of anatomical feature types; an anatomical feature processor arranged to isolate anatomical feature elements of the user from within received first image data; a controller arranged to compare the isolated anatomical feature elements with information in the anatomical features database to determine the user's anatomical feature type within each category of anatomical features; an instructions database comprising a plurality of image processing instructions, each image processing instruction corresponding to one of the said anatomical feature types; an image processor arranged to image process second image data by carrying out a said image processing instruction corresponding to the user's determined anatomical feature type for a first category of the categories of anatomical features, wherein the second image data comprises a representation of the user; and a display arranged to display the image processed second image data.

According to an aspect of the invention, there is provided an image processing system for processing an image of a user, comprising: an anatomical features database comprising information on a plurality of category of anatomical features, wherein each category of anatomical features includes a number of anatomical feature types; a controller arranged to processing received first image data to show a representation of a first anatomical feature type within a first category of anatomical features overlaid on the first image data, receiving a user input for scrolling between different anatomical feature types within the first category of anatomical features overlaid on the first image data, receiving a user selection relating to the user's choice of their anatomical feature type for the first category of anatomical features, and repeating this step for each of the other categories of anatomical feature, wherein the controller is arranged to store a representation of the user as second image data in a computer-readable memory, wherein the second image data is obtained based on the user's choice of their anatomical feature type for each category of anatomical features; an instructions database comprising a plurality of image processing instructions, each image processing instruction corresponding to one of the said anatomical feature types; an image processor arranged to image process the second image data by carrying out a said image processing instruction corresponding to the user's determined anatomical feature type for one of the categories of anatomical features; a display arranged to display the image processed second image data.

The image processing system may be provided in a single computer apparatus (e.g. a mobile device such as a tablet or smartphone) or as a number of separate computer apparatuses. The instructions to enable a computer apparatus to perform as the image processing system according to embodiments of the invention may be provided in the form of an app or other suitable software.

The image processing system may be for providing tutorials to a user. Hence, such embodiments may provide a tutorial system to enable a user to see a tutorial (e.g. a makeup tutorial) applied to their anatomical features, with the tutorial being tailored specifically for their anatomical features.

According to an aspect of the invention, there is provided a computer-implemented method for processing a facial image, comprising the steps of: storing a database of facial image components; categorising the stored facial image components into a plurality of feature types; storing a plurality of image transformations in association with each stored facial image component; receiving an image of a user's face; generating a composite image representing the user's face, the composite image comprising a plurality of components, each component associated with one of the plurality of feature types; performing facial recognition to determine stored facial image components of each of the plurality of feature types which match the received image; receiving a selection of an image transformation stored in association with the determined facial image component of the selected feature type; dividing the selected image transformation into a plurality of discrete sub-transformations; performing each of the sub-transformations in sequence to the feature of the composite image associated with the selected feature type; generating a sequence of modified composite images each corresponding to the performance of each respective sub-transformation of the sequence of sub-transformations to the composite image; and displaying the plurality of modified composite images.

According to an aspect of the invention, there is provided a computer-implemented method of processing an image of a user to provide a mirror view and an application view in a mobile device comprising a front facing camera and a touch screen display, comprising: receiving first video image data of a user from the front facing camera of user; displaying the first video image data of the user in a mirror window in a first region of the touch screen display, and simultaneously displaying application data of an application running on the mobile device in an application window in a second region of the touch screen display; receiving a user interaction from the touch screen indicating a directionality between the first region and the second region;

wherein if the directionality represents a direction from the first region to the second region, the method comprises increasing the size of the mirror window and decreasing the size of the application window; and wherein if the directionality represents a direction from the second region to the first region, the method comprises increasing the size of the application window and decreasing the size of the mirror window.

In some embodiments, the method comprises displaying the mirror window in a full screen mode, and receiving a user interaction from the touch screen indicating a directionality representing a direction from the second region to the first region, and decreasing the size of the mirror window and showing the application window.

In some embodiments, the method comprises displaying the application window in a full screen mode, and receiving a user interaction from the touch screen indicating a directionality representing a direction from the first region to the second region, and decreasing the size of the application window and showing the mirror window.

According to an aspect of the invention, there is provided a mobile device comprising: a front facing camera arranged to receive first video image data of a user from the front facing camera of user; a touch screen display arranged to display the first video image data of the user in a mirror window in a first region of the touch screen display, and simultaneously to display application data of an application running on the mobile device in an application window in a second region of the touch screen display; and a controller arranged to receive a user interaction from the touch screen indicating a directionality between the first region and the second region; wherein if the directionality represents a direction from the first region to the second region, the method comprises increasing the size of the mirror window and decreasing the size of the application window; and wherein if the directionality represents a direction from the second region to the first region, the method comprises increasing the size of the application window and decreasing the size of the mirror window.

According to an aspect of the invention, there is provided a computer-implemented method of providing a tutorial to a user, comprising: storing an anatomical features database comprising information on a plurality of categories of anatomical features in a computer-readable memory, wherein each category of anatomical features includes a number of anatomical feature types; receiving first image data of a user, the first image data representing anatomical features of the user; processing the received first image data to show a representation of a first anatomical feature type within a first category of anatomical features overlaid on the first image data, receiving a user input for scrolling between different anatomical feature types within the first category of anatomical features overlaid on the first image data, receiving a user selection relating to the user's choice of their anatomical feature type for the first category of anatomical features, and repeating this step for each of the other categories of anatomical features;

storing a representation of the user as second image data in a computer-readable memory, wherein the second image data is obtained based on the user's choice of their anatomical feature type for each category of anatomical features; storing an instructions database comprising a plurality of image processing instructions in a computer-readable memory related to tutorial steps for each category of anatomical features, each image processing instruction corresponding to one of the said anatomical feature types and relating to a tutorial step for said one of the said anatomical feature types; image processing the second image data by carrying out a said image processing instruction corresponding to the user's determined anatomical feature type for one of the categories of anatomical features, displaying the image processed second image data, and repeating this step for all the categories of anatomical features in a sequence to provide a tutorial to the user.

According to an aspect of the invention, there is provided a computer-implemented method of providing a tutorial to a user, comprising: storing an anatomical features database comprising information on a plurality of categories of anatomical features in a computer-readable memory, wherein each category of anatomical features includes a number of anatomical feature types; receiving first image data of a user, the first image data representing anatomical features of the user; processing the received first image data to isolate anatomical feature elements of the user from within the first image data; comparing the isolated anatomical feature elements with information in the anatomical features database to determine the user's anatomical feature type within each category of anatomical features; storing a representation of the user as second image data in a computer-readable memory; storing an instructions database comprising a plurality of image processing instructions in a computer-readable memory, each image processing instruction in corresponding to one of the said anatomical feature types and relating to a tutorial step for said one of the said anatomical feature types; image processing the second image data by carrying out a said image processing instruction corresponding to the user's determined anatomical feature type for one of the categories of anatomical features, displaying the image processed second image data, and repeating this step for all the categories of anatomical features in a sequence to provide a tutorial to the user.

### DESCRIPTION OF THE DRAWING FIGURES

Embodiments of the present invention will now be described, by way of example only, with reference to the accompanying drawings, in which:

FIG. 1 shows a schematic illustration of a makeup tutorial system according to a first embodiment of the invention;

FIGS. 2a to 2g show example sets of facial features that may be used with the first embodiment of the invention;

FIG. 3 shows a flow chart of the operation of the first embodiment;

FIGS. 4a to 4c show example displays when using an embodiment of the invention;

FIGS. 5a to 5c show example displays when using an embodiment of the invention;

FIGS. 6a to 6c show example displays when using an embodiment of the invention;

FIG. 7 shows an example display when using an embodiment of the invention;

FIGS. 8a to 8e show example makeup styles;

FIGS. 9a to 9g show example makeup instructions when using an embodiment of the invention;

FIG. 10 shows a flow chart of the operation of an embodiment of the invention;

FIG. 11 shows a schematic illustration of an image processing apparatus according to a second embodiment of the invention;

FIG. 12 shows a schematic illustration of an image processing apparatus according to a third embodiment of the invention;

FIG. 13 shows an example display when using an embodiment of the invention;

FIG. 14 show an example display of another embodiment of the invention; and

FIGS. 15a to 15e show example displays of another embodiment of the invention;

FIG. 16 shows a schematic illustration of a mobile device according to another embodiment of the invention.

### DETAILED DESCRIPTION

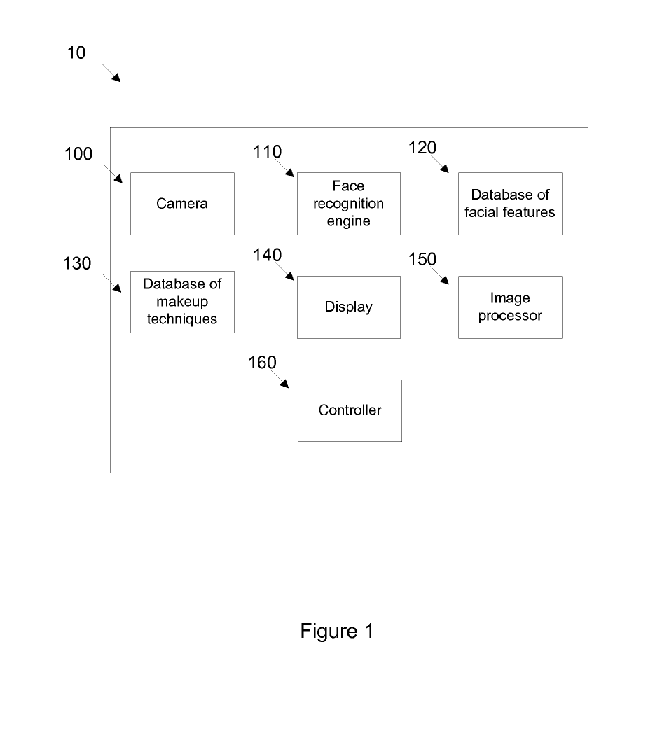

FIG. 1 shows a schematic diagram of a tutorial system 10 according to a first embodiment of the invention. In this embodiment, the tutorial system 10 is for makeup, but embodiments of the invention are not limited thereto.

In this embodiment there is a camera 100, a face recognition engine 110, a database of facial features 120, a database of makeup techniques 130, a display 140, an image processor 150, and a controller 160.

In this embodiment, the tutorial system 10 is implemented on a mobile device, such as a smartphone or tablet. However, other embodiments of the invention could be implemented in different ways, as discussed below. The instructions to enable a smartphone to perform as an image processing system according to embodiments of the invention may be provided in the form of an app or other suitable software.

The camera 100, which in this embodiment is a forward facing camera of a smartphone, can take an image of a user's face. This image can then be used by the face recognition engine 110 to analyse the features of the user's face.

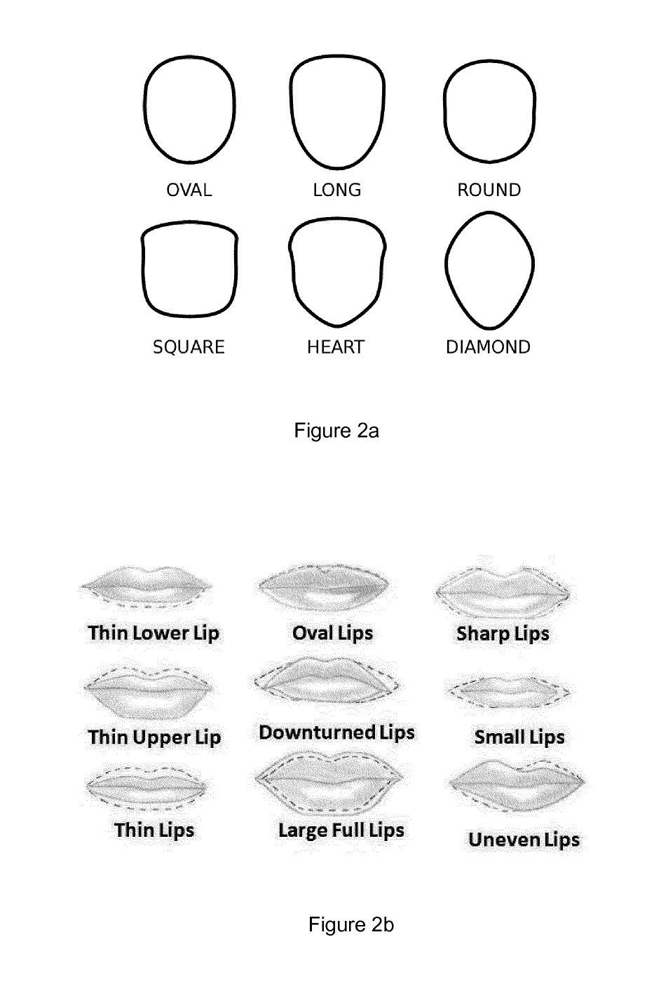

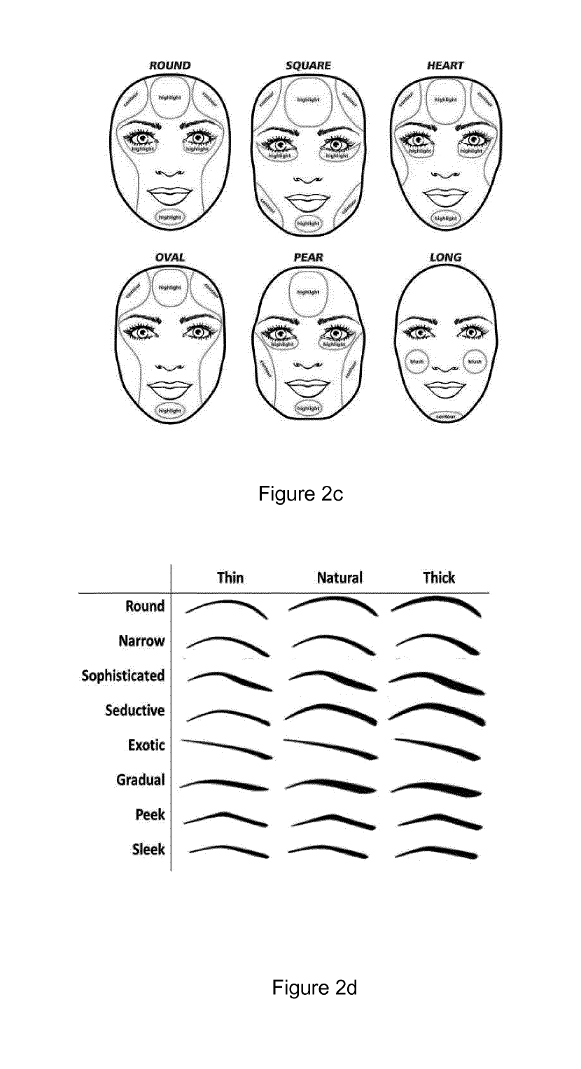

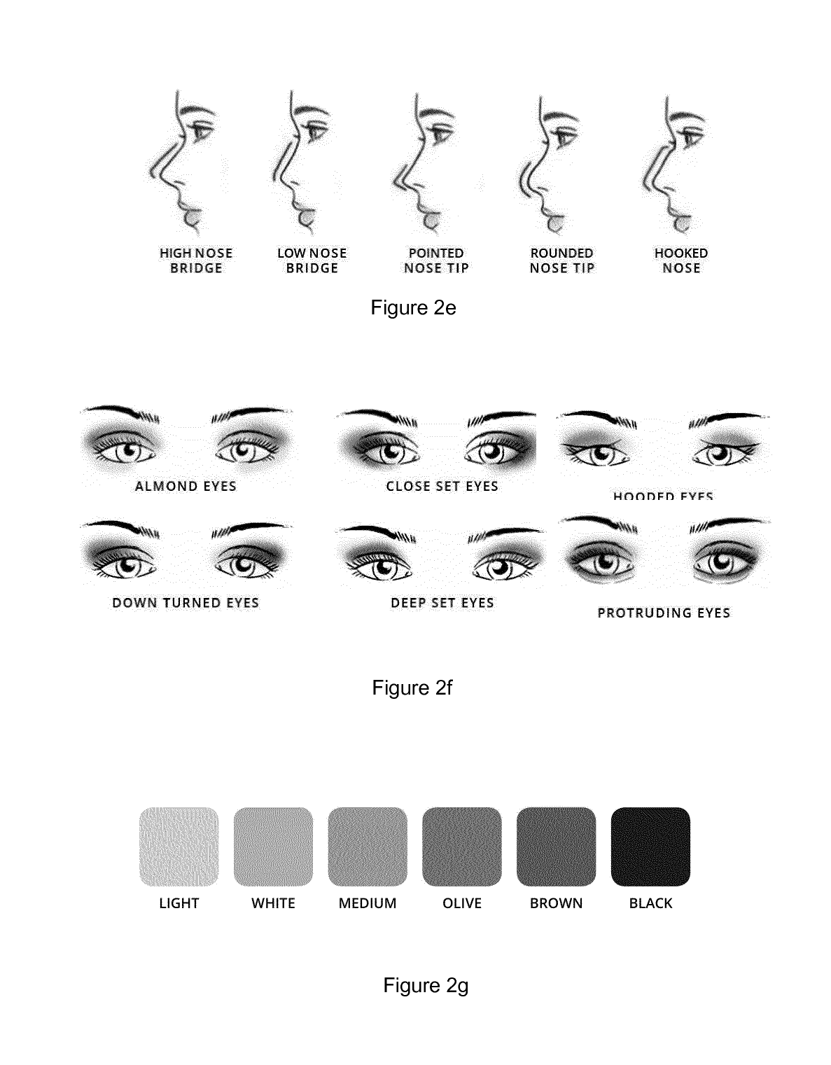

The database of facial features 120 stores information on different facial feature types within different categories of facial feature. In this embodiment, the database of facial features 120 stores information on different types of facial features within the following categories: face shape, lip shape, makeup contouring pattern, eye brow shape, nose shape, eye shape, and skin tone. An example set of facial feature types for these example categories is shown in FIGS. 2a to 2g.

In FIG. 2a, for the category of “face shape”, there are shown six different example face shapes: “oval”, “long”, “round”, “square”, “heart” and “diamond”.

In FIG. 2b, for the category of “lip shape”, there are shown nine different lip shapes: “thin lower lip”, “oval lips”, “sharp lips”, “thin upper lip”, “downturned lip”, “small lips”, “thin lips”, “large full lips”, and “uneven lips”.

In FIG. 2c, for the category of “makeup contouring pattern”, there are shown six different makeup contouring patterns: “round”, “square”, “heart”, “oval”, “pear”, and “long”.

In FIG. 2d, for the category of “eye brow shape”, there are shown twenty four different eye brow shapes: with eight shapes (“round”, “narrow”, “sophisticated”, “seductive”, “exotic”, “gradual”, “peek”, and “sleek”) each with three variations (“thin”, “natural”, and “thick”).

In FIG. 2e, for the category of “nose shape”, there are shown five different nose shapes: “high bridge nose”, “low bridge nose”, “pointed nose tip”, “rounded nose tip”, and “hooked nose”.

In FIG. 2f, for the category of “eye shape”, there are shown six different eye shapes: “almond eyes”, “close set eyes”, “hooded eyes”, “down turned eyes”, “deep set eyes”, and “protruding eyes”.

In FIG. 2g, for the category of “skin tone”, there are shown six different skin tones: “light”, “white”, “medium”, “olive”, “brown”, and “black”.

It will, of course, be appreciated that the example facial feature types shown in FIGS. 2a to 2g are purely illustrative, and that embodiments of the invention could use other types and or categories of facial features. For example, other embodiments could use the same facial feature categories as shown in FIGS. 2a to 2g, with different (e.g. more or less, or differently labelled) feature types within each category. Alternatively, other embodiments could use different facial feature categories to those shown in FIGS. 2a to 2g (e.g. more or less, or differently labelled), or a mixture of the same and different facial feature categories and/or types.

Other embodiments could replace the database of facial features 120 with a database relating to other types of anatomical information, e.g. relating to hand and nails.

The database of makeup techniques 130 stores tutorial information for different for makeup styles. For example, the tutorial information may aim to show the user how to apply that makeup style, and would typically take the form of step-by-step instructions for the user. Other embodiments could replace the database of makeup techniques 130 with a database relating to other types of tutorial information, e.g. skin care.

As a purely illustrative and simplified example, the database of makeup techniques 130 may store information relating to a “Winter Warming” makeup style, with different instructions correspond to each facial feature type. As an example, for the “eye shape”, the database of makeup techniques 130 for the “Winter Warming” makeup style, may store the information in Table 1:

TABLE 1

| Eye shape Category | Data |
|---|---|
| almond eyes | Instruction A1 |
| close set eyes | Instruction A2 |
| hooded eyes | Instruction A3 |
| down turned eyes | Instruction A4 |
| deep set eyes | Instruction A5 |
| protruding eyes | Instruction A6 |

As a further example, for the “lip shape”, the database of makeup techniques 130 for the “Winter Warming” makeup style, may store the information in Table 2:

TABLE 2

| Lip shape Category | Data |
|---|---|
| thin lower lip | Instruction B1 |
| oval lips | Instruction B2 |
| sharp lips | Instruction B3 |
| thin upper lip | Instruction B4 |
| downturned lip | Instruction B5 |
| small lips | Instruction B6 |
| thin lips | Instruction B7 |
| large full lips | Instruction B8 |
| uneven lips | Instruction B9 |

Hence, in this way, for each makeup style, the database of makeup techniques 130 can store different instructions for each type of facial feature. In other words, compared to conventional tutorials that may store a single tutorial related to one example face (e.g. in the case of a video of a female performer applying makeup to herself), the database of makeup techniques 130 stores much more detailed tutorial information.

For each stored makeup style, the database of makeup techniques 130 may store a set of step-by-step instructions for the user to follow to achieve that make-up style. The order of the steps (e.g. eyes first or lips first) may vary depending on the makeup style or may be fixed for each style (e.g. with each makeup style always starting with the eyes), with embodiments of the invention not being limited in this way.

Hence, the step-by-step instructions for each makeup style will vary depending on the facial features of the user.

In this embodiment, the controller 16o controls the operation of the camera 100, the face recognition engine 110, the database of facial features 120, the database of makeup techniques 130, the display 140, and the image processor 150.

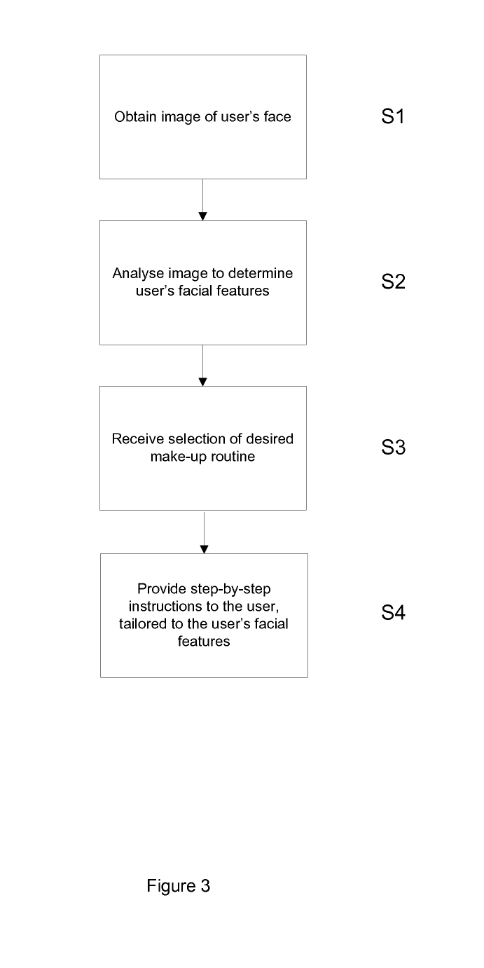

An example of how the first embodiment may be used will be explained in relation to FIG. 3.

FIG. 3 shows a flow chart of the use of the makeup tutorial system 100 according to the first embodiment.

In step S1, the camera 100, which in this embodiment is a forward facing camera of a smartphone, is used to take image of the user's face under control of the controller 160. In alternative embodiments, the image of the user's face may be obtained in other ways, e.g. received from an external device (e.g. an image server).

This image is then stored in a memory (not shown). Under control of the controller 160, the face recognition engine 110 analyses the stored image in step S2 to determine the features of the user's face. In this step, the face recognition engine 110 analyses the stored image and, within each facial feature category, determines which types of facial feature shown in the image is the best match to the types of facial features stored in the database of facial features 120.

For example, the face recognition engine 110 may analyse the stored image and determine that the user's face has the facial feature set shown in Table 3:

TABLE 3

| Facial feature category | Facial feature type |
|---|---|
| face shape | long |
| lip shape | thin lower lip |
| makeup contouring pattern | oval |
| eye brow shape | gradual |
| nose shape | low bridge nose |
| eye shape | hooded eyes |
| skin tone | medium |

In this embodiment, the face recognition engine 110 creates an avatar corresponding to the user's face.

Then, at step S3, the user makes a selection of the type of makeup style that they are interested in. In this embodiment, the user is provided with a user interface (UI) that is displayed on the display 140 to enable the user to make a selection of the desired makeup style from the makeup styles stored in the database of makeup techniques 130.

At step S4, the user is then presented with step-by-step instructions for the chosen makeup style on the display 140. In contrast to conventional arrangement, the step-by-step instructions are tailored for the user.

For example, if the chosen makeup style is “Winter Warming” and the first step of this makeup style is to apply makeup to the eyes of the user, then the instructions for the first step will depend on the eye shape of the user. For example, for the user shown in Table 3 (i.e. having the eye shape “hooded eyes”), they will be provided with Instruction A3 in the example of Table 1.

Similarly, for the step of the makeup instructions corresponding to lip shape, the user shown in Table 3 (i.e. having the lip shape “thin lower lip”), they will be provided with Instruction B1 in the example of Table 2.

It will also be appreciated that the step-by-step instructions for the chosen makeup style may have any number of steps and more than one step may be dependent on the same facial feature category. For example, in an example makeup style instruction set, it may be desired to apply makeup to the eyes in an early stage (e.g. step 1 of the makeup style instruction set) and again in a later step (e.g. step 9 of the makeup style instruction set). Hence, in this example, both the specific instructions for steps 1 and 9 of this makeup style instruction set would be chosen to correspond to the type of the user's eyes.

Furthermore, in this example, the individual steps of a chosen makeup style instruction set are determined based on the facial features of the user, e.g. Instruction A3 in the example of Table 1 for a user with “hooded eyes”. However, it will be appreciated that some steps of a makeup style instruction set may involve multiple facial features. In such circumstances, the database of makeup techniques 130 may store different instructions for different pairs (or higher combinations) of facial features. For example, a certain step of a makeup style may have different instructions depending on whether the user has certain combinations of eye shape and eye brow shape.

In this embodiment, the step-by-step instructions are shown on the display 140, by overlaying graphical elements (e.g. coloured layers and/or animations) over the avatar of the user. This is achieved by image processing by the image processor 150 using the information stored in the database of makeup techniques 130.

Makeup tutorial videos are popular on streaming video sites. A user would typically select a video and watch the performer apply makeup to his or her self. Such videos are, however, often hard to follow for users, particularly if the user is not skilled at makeup application. The same is true for beauty treatment tutorials, such as skin care and nails. Embodiments of the invention such as the one discussed above provide numerous advantages when compared to traditional tutorial videos. The tutorial of such embodiments of the invention is tailored to the anatomy of the user, which is a large benefit when compared to just being shown the tutorial with respect to a performer. Furthermore, the user may select a certain step or cycle through the steps as they wish, which is not possible with a conventional video.

Furthermore, using such embodiments, retention of information is better using the invention compared to conventional alternatives. This is because the user can take their time, repeat and practice the technique.

Such embodiments can also provide a quick referencing system to remind the user of the key steps to creating the look and help prevent the user going back to their old methods of application. Furthermore, once a tutorial has been created for a user, it may be stored for repeated playback.

Such embodiments can enable the user to learn about their own features something they may not already know. Such embodiments can also enable the user to learn make up technique on their own face.

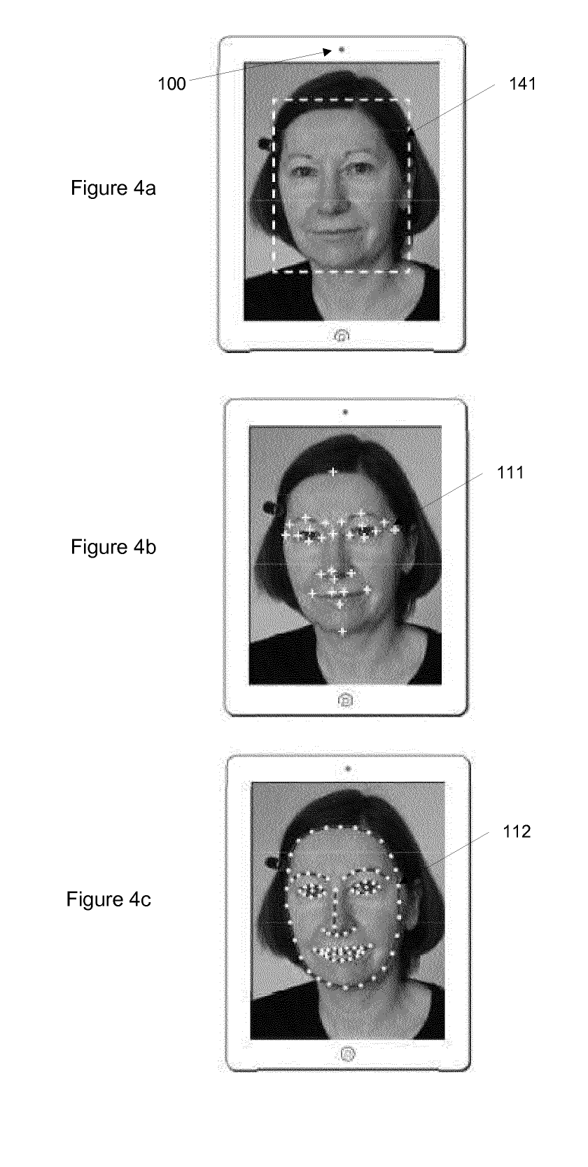

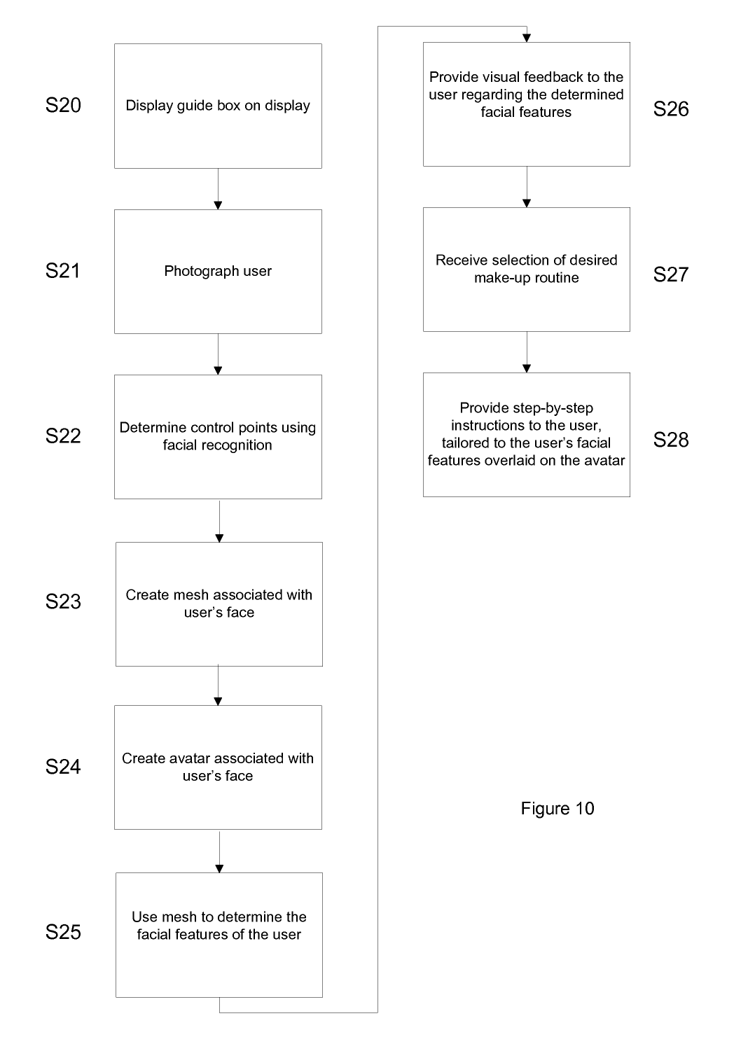

An example of how the first embodiment could be used in practice will now be discussed in relation to FIGS. 4a to 9g. A flow chart of operation is shown in FIG. 10.

In this embodiment, the makeup tutorial system 10 is shown as a smartphone with a forward facing camera 100. As shown in FIG. 4a, the user has used the forward facing camera 100 to take a photograph of her face.

In this example, before the photograph was taken, the display 140 shows a box 141 to prompt the user to place their face within the highlighted area. This process is shown as step S20 in FIG. 10, with the step of photographing the user shown in step S21.

In FIG. 4b, the face recognition engine 110 analyses the stored image and determines a first number of control points 111 in the displayed image. In FIG. 4c, the face recognition engine 110 has analysed the stored image further and has determined a second number of control points 112 in the displayed image. The images shown in FIG. 4b and FIG. 4c may be displayed to the user, or this analysis may take place purely in the background. The step of determining control points is shown in step S22 in FIG. 10.

The first number of control points 111 in FIG. 4b may correspond to conventional face recognition. The second number of control points 112 in FIG. 4c may represent a more complex analysis with more facial points. The more analysis done regarding the hairline and jaw line will define the face shape better and give more accuracy.

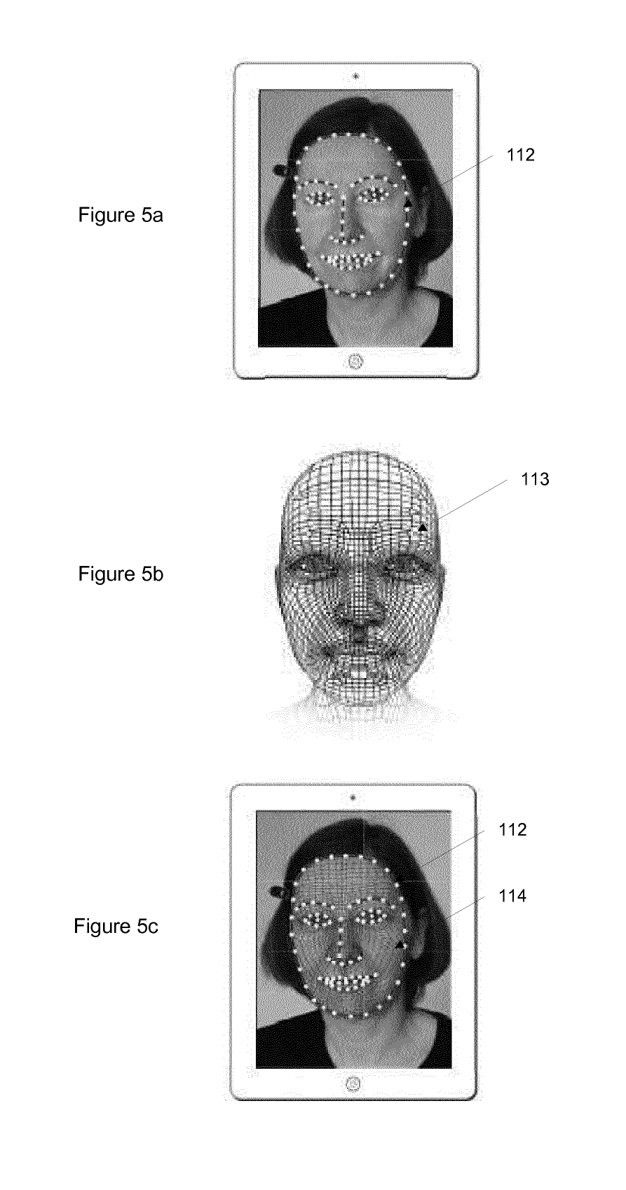

As shown schematically in FIGS. 5a to 5c, the control points 112 are used by the face recognition engine 110 along with a template mesh 113 (see FIG. 5b) stored in the database of facial features 120 (or another memory). As shown in FIG. 5c, the template mesh 113 is manipulated by the face recognition engine 110 to match the control points 112. This process is shown as step S23 in FIG. 10. It will be appreciated that the template mesh 113 (see FIG. 5b) need not be displayed to the user.

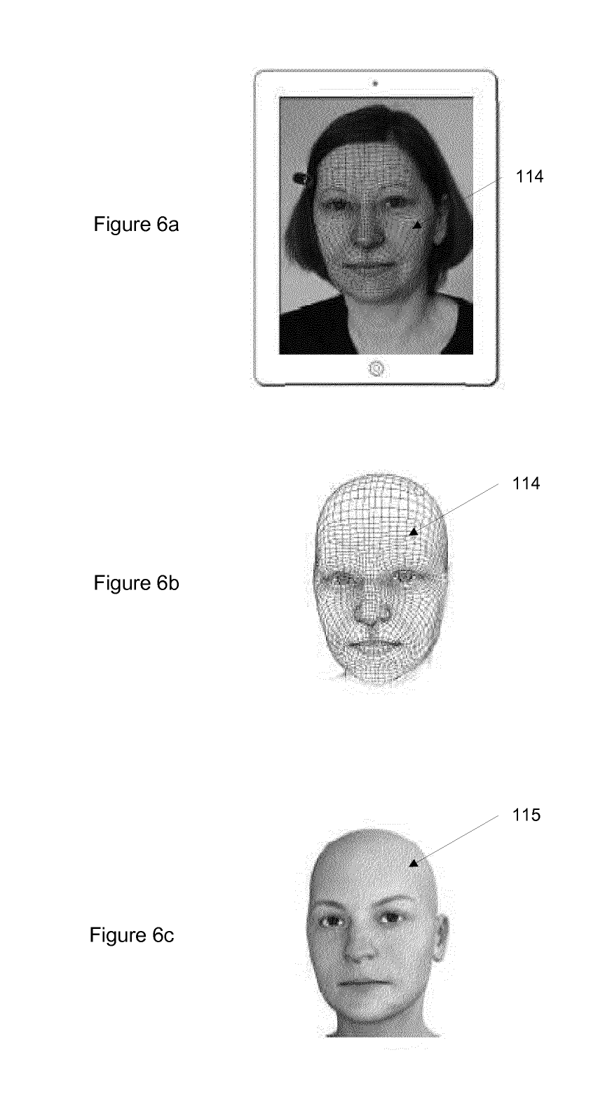

As shown schematically in FIG. 6a, the manipulated mesh 114 may be overlaid in real-time over the image of the user. Alternatively, this analysis may take place purely in the background and need not be displayed to the user.

The manipulated mesh 113 is then isolated (see FIG. 6b), which may or may not be shown to the user. An avatar 115 of the user can then be created by the face recognition engine 110 as shown in FIG. 6c. This process is shown as step S24 in FIG. 10. This avatar 115 may or may not be directly displayed to the user.

The face recognition engine 110 can then determine the facial features corresponding to the user for each facial feature category. In order to achieve this, the face recognition engine 110 uses the mesh 114 to determine the best match of the user's facial features to those stored in the database of facial features 120. This process is shown as step S25 in FIG. 10.

For example, for the eye shape category, the face recognition engine 110 could extract the control points 112 of the mesh 114 that correspond to the outline of the user's eyes and determine an eye shape. This determined eye shape can then be compared to the stored eye shapes (see FIG. 2f) and a best match determined. It will be appreciated that there are a number of comparison techniques that could be used for this.

The mesh 114 can be used in either real-time (video feed) or on a still image, however the real-time live video feed allows for users to change angles of their face to see how the makeup looks from different perspectives, whereas a still image only allows them to see the look from the one view.

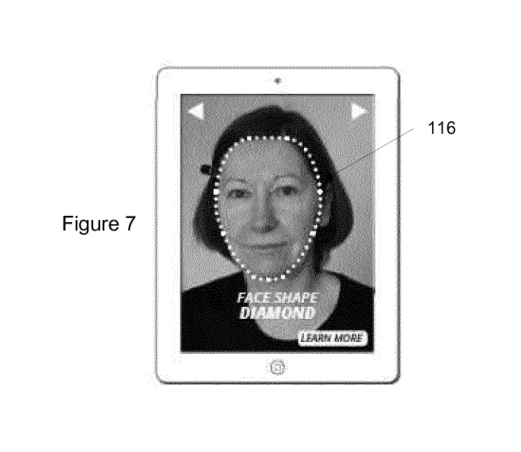

In this embodiment, the user is then provided with visual feedback regarding their facial features, as shown by way of example in FIG. 7. This process is shown as step S26 in FIG. 10. In this example, the face recognition engine 110 has used the mesh 114 to determine that the user has a “diamond” face shape. As shown in FIG. 7, the image processor 150 may display the outline 116 of the “diamond” face shape over the displayed image of the user. In order to do this, the image processor 150 can scale the stored outline corresponding to the “diamond” face shape (see FIG. 2a) to the user's face using the mesh 113.

This process can be done for all the facial feature categories. In this way, the user can be provided with visual feedback regarding their facial features. In some embodiments, a user interface may be provided to the user to enable the user to tweak their facial features. In other words, in some circumstances, the user may wish to select a different face shape to the one determined by the face recognition engine 110. In other embodiments, step S26 may be skipped.

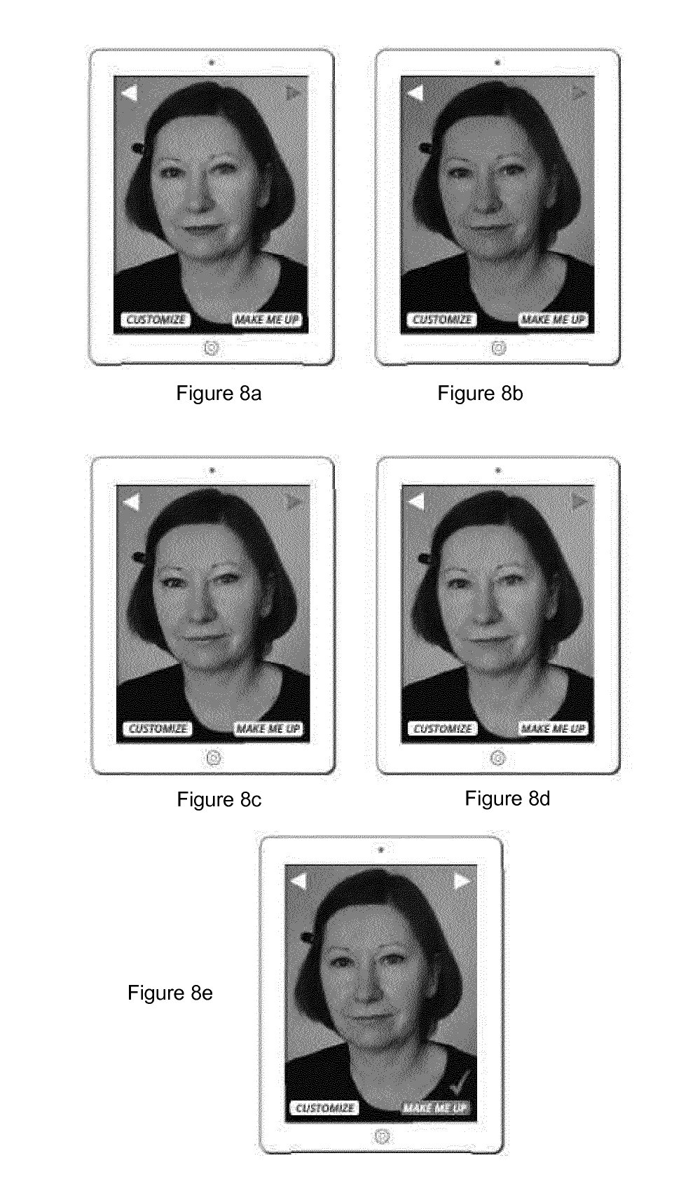

In this embodiment, the user then makes a selection of the type of makeup styles that they are interested in. This process is shown as step S27 in FIG. 10. In this embodiment, the user can select a number of makeup styles as shown in FIGS. 8a to 8c. As shown in FIGS. 8a to 8c, in some embodiments, the user make move between makeup styles using arrows.

For each makeup style, the image processor 150 processes the image of the user to show the effect of the makeup style to the user. In order to do this, the database of makeup techniques 130 stores a set of image processing techniques for each makeup style (e.g. darken a certain area, colour a certain area a certain shade). The image processor 150 then uses this stored information along with the mesh 113 to image process the stored image of the user to preview the different makeup styles. Hence, the database of makeup techniques 130 may include these image processing techniques to be applied to the whole face of the user to act as makeup previews.

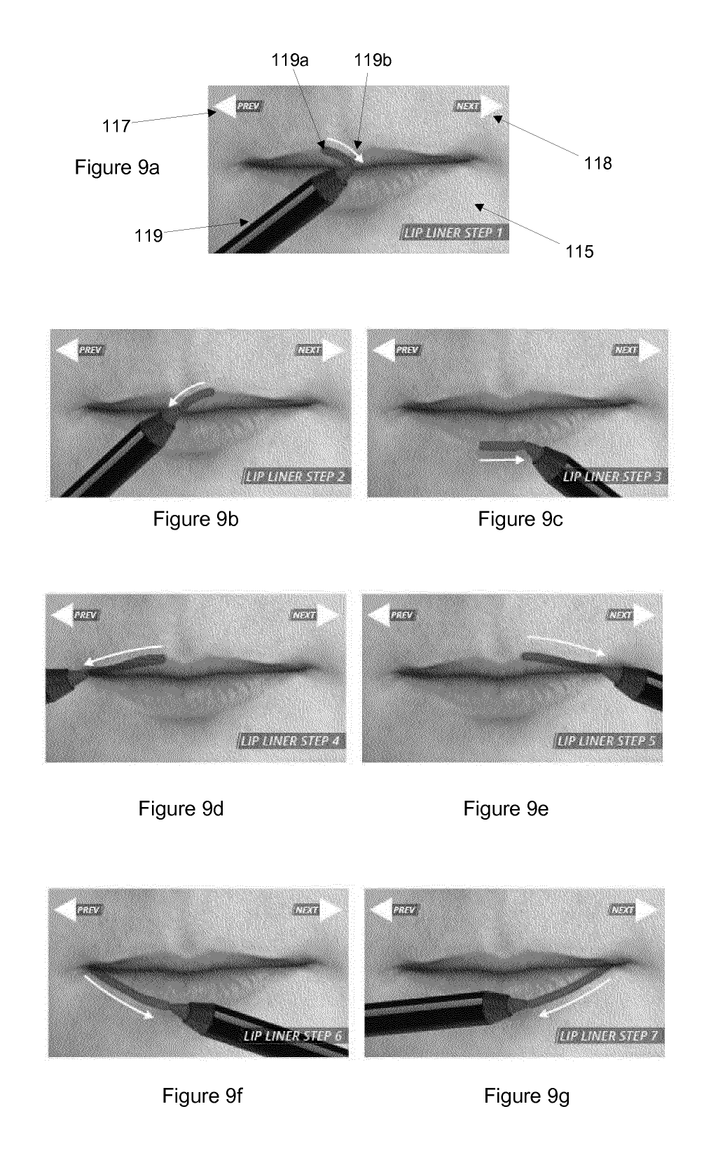

The image processing techniques may include colour layers to different parts of the Once the user makes a selection of the type of makeup styles that they are interested in, the user is then presented with step-by-step instructions for the chosen makeup style. This process is shown as step S28 in FIG. 10. The process of the provision of the step-by-step instructions is illustrated in FIGS. 9a to 9g.

FIGS. 9a to 9g show an example first seven steps of a chosen makeup style. All of these steps relate to the lips of the user, as they relate to the application of lip liner.

As a result, all of these steps include instructions specific to the lip shape of the users (e.g. one of the lip shapes shown in FIG. 2b).

In order to show the user the step-by-step instructions, in this embodiment, the controller 160 queries the database of makeup techniques 130 to determine the first step (FIG. 9a) of the chosen makeup style. As shown in FIG. 9a, this first step involves the application of lip liner, and the instruction is displayed in the form of an animation showing a lip liner pen 119 applying the makeup in the correct pattern to the avatar 115 of the user. In this example, the display 140 shows a close up portion of the mouth/lip area of the avatar 115.

In order to achieve this, the image processor 150 uses the instruction information in the database of makeup techniques 130 to determine the correct image processing technique to apply to the avatar 115 of the user for each step.

In other words, the image processor 150 matches a stored animation showing a lip liner pen 119 to the correct position using the control points 112 of the mesh 113 associated with the avatar and shows the amination in the correct position. For example, the stored animation may start at the control point 112 associated with a certain position of the lip (e.g. the highest point on the user's right side upper lip) and move to a control point 112 associated with another position of the lip (e.g. the centre of the upper side of the user's upper lip).

The image processor 150 also shows the effect of the makeup application on the avatar 115 by colouring the correct portion of the avatar 115 as seen by the user. The image processor 150 may achieve this by overlaying the colour information 119a as a semi-transparent layer over the displayed avatar 115, along with a directional arrow 119b to show movement direction.

It will be appreciated that such things as directional arrows, coloured regions, colour information and the like overlaid over the avatar 115 will enable the user to understand how to apply makeup in each step. Other embodiments or other steps could use any appropriate graphical tool overlaid on the avatar 115 for this. For example, a representation of the hand could be shown to further illustrate how to apply the makeup.

In other embodiments, the step-by-step instructions could also include verbal instructions as well as visual instructions. For example, the tutorial system 10 could be provided with a microphone (not shown) for providing such verbal instructions. The verbal instructions could be stored in the database of makeup techniques 130.

FIGS. 9b to 9g all show steps 2 to 7 of the application of lip liner. As shown in FIGS. 9a to 9g, the user can cycle through the steps. In other words, the user can move forward and backward through steps 1 to 7 using previous and next arrows 117 and 118. In this way, the user can progress through the makeup tutorial at their own pace, and can watch the instructions associated with a certain step multiple times before progressing to the next one.

In the above embodiment, the template mesh 113 (i.e. base mesh) is manipulated to match the control points 112 recognised by the facial scan. This is done in this embodiment by having a number of preset shapes for each of the components of a face (as illustrated/broken down in FIGS. 2a to 2g) and the controller 16o morphs the base mesh 113 per facial component to the best fit of the user's facial features.

The morphed mesh 114 is then used as a layer above the user's face and drawn in real-time to add makeup to the users face when they browse styles. This mesh 114 may be invisible apart from any colour or shapes added to a user's avatar 115 as part of a style or chosen look. As an example, the lips of this mesh 114 can be colourised to any chosen colour, which is then layered over a user's face with a small amount of transparency so it blends and looks believable.

As discussed, some embodiments of the invention can carry out facial recognition to determine the facial features of the user and provide tailored makeup instructions for the user based on their own facial features. This provides substantial advantages over watching a simple tutorial video.

Furthermore, while some embodiments create a 3D avatar of the user and use this to show the makeup instruction (see FIGS. 9a to 9g), in other embodiments, the makeup instructions may be applied to the stored image of the user. An advantage of using a 3D avatar of the user is that it allows for greater scope for manipulation, e.g. rotating the display of the 3D avatar to show how to apply makeup to different features. Using a 3D avatar, allows the control of what is presented to a user, which would include, different angles if required by the makeup application technique being shown or animations of brush techniques/correct directions of movement for each stage of makeup application.

In the discussion of the embodiment in relation to FIGS. 4a to 9a, a still image of the user is captured and this is manipulated. However, embodiments of the invention can capture video of the user. For example, on the assumption that the user kept relatively still (e.g. keeping their head in roughly the same place), the mesh 114 of the user could be overlaid onto a video feed captured by the camera 100. For example, the previews of makeup styles (see FIGS. 8a to 8e) could be shown onto a video feed of the user. In order to achieve this, the image processor 150 could apply colour layer data over the video feed, corresponding to the identified control points.

Embodiments of the invention have been discussed in relation to a mobile device (e.g. smartphone or tablet). However, embodiments of the present invention are not limited in this way.

The above mentioned embodiments may provide a tutorial system for a user. Such systems have great benefits when compared to traditional static tutorials such as videos.

The above mentioned embodiments may be modified for other uses. For example, the system of FIG. 1 could also be used for skin care tutorials. To implement this modification, the database of makeup techniques 130 could be replaced by a database of skincare techniques (not shown). In a similar way, the system of FIG. 1 could be modified to provide a tutorial for anything related to the user's face.

Furthermore, above mentioned embodiments may be modified for other uses apart from the face. For example, the system of FIG. 1 could also be used for nail tutorials. To implement this modification, the database of facial features 120 and the database of makeup techniques 130 could be replaced by a database of hand and nail features and a database of nail styles (not shown).

Such an embodiment could operate by 1) taking an image of the user's hand; 2) performing hand recognition to determine the individual's hand size type, shape type, width type, and length of fingers type (from information in the database of hand and nail features); 4) provide a tutorial for how to best apply nail polish based on the user's hand and nail features. The tutorial could be based on a stored nail style in the database of nail styles (not shown).

For nails, there may be about six different nail shapes to suit the shape of the person's hand. For example, a small hand with stubby fingers would not want short square nails but long pointed nails to make the hand and fingers look more elegant. The tutorial could also cover how to file nails correctly and paint without damaging the nail etc.

It will be appreciated that the hardware used by embodiments of the invention can take a number of different forms. For example, all the components of embodiments of the invention could be provided by a single device, or different components of could be provided on separate devices. More generally, it will be appreciated that embodiments of the invention can provide a system that comprises one device or several devices in communication.

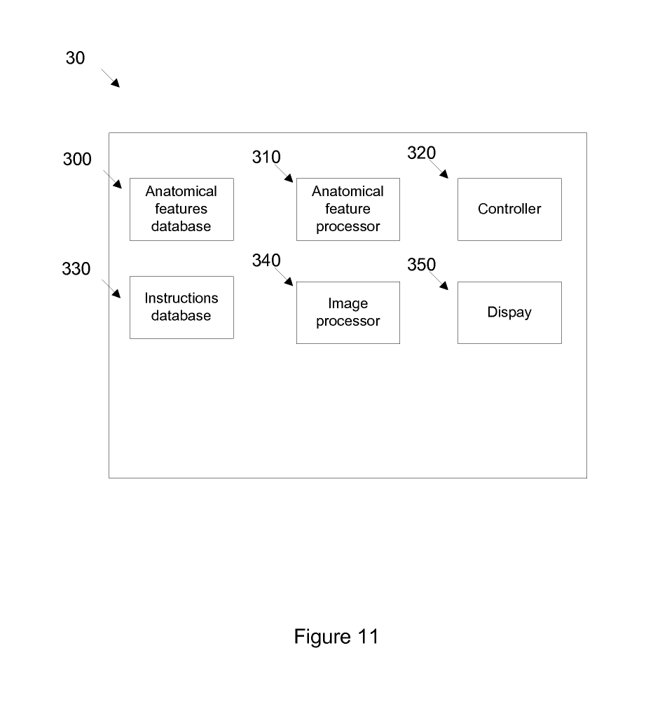

FIG. 11 shows a schematic diagram of an image processing apparatus 30 according to a second embodiment of the invention. In this embodiment there is an anatomical features database 300, an anatomical feature processor 310, a controller 320, an instructions database 330, an image processor 340, and a display 350.

The anatomical features database 300 comprises information on at least one category of anatomical features, wherein each category of anatomical features includes a number of anatomical feature types.

The anatomical feature processor 310 is arranged to isolate anatomical feature elements of the user from within received first image data. The first image data may be received via a camera (not shown) or retrieved from a local or remote memory or file store.

The controller 320 is arranged to compare the isolated anatomical feature elements with information in the anatomical features database to determine the user's anatomical feature type within each category of anatomical features.

The instructions database 330 comprises a plurality of image processing instructions, each image processing instruction corresponding to one of the said anatomical feature types.

The image processor 340 is arranged to image process second image data representing the user by carrying out a said image processing instruction corresponding to the user's determined anatomical feature type for a first category of the categories of anatomical features.

As a result, in this embodiment, first image data representing anatomical features of the user is received, and this is processed by the anatomical feature processor 310 to isolate anatomical feature elements of the user from within the first image data. The isolated anatomical feature elements are compared with information in the anatomical features database by the controller 320 to determine the user's anatomical feature type within each category of anatomical features.

Then, image processing is carried out on second image data that represents the user by the image processor 340, with the image processing comprising carrying out a said image processing instruction corresponding to the user's determined anatomical feature type for a first category of the categories of anatomical features. The display 350 then displays the image processed second image data.

The second embodiment can be considered to be a generalised system when compared to the first embodiment. In such an embodiment, the anatomical features database 300 may, for example, store information relating to facial features of the user. In such an example, the anatomical features database 300 may store the same or similar information to that stored in the database of facial features 120 mentioned in relation to FIG. 1. Alternatively, the anatomical features database 300 may store different facial features. As an example, the features relevant to a skin care tutorial might well be different to those relating to a makeup tutorial.

In other examples, the anatomical features database 300 may store information on anatomical features relating to the hand and nails of the user. In other examples, the anatomical features database 300 may store information on other anatomical features of the user. In general, the anatomical features database 300 may store information on any anatomical features of the user that the system is designed to provide tailored image processing for.

In the second embodiment, the image processing of the second image may comprise carrying out the image processing instructions corresponding to the user's determined anatomical feature types for all the categories of anatomical features.

Each image processing instruction comprises instructions to enable the image processor 340 to process the second image data for a desired effect. For example, the image processing instructions may comprise at least one of a graphical effect to be applied to at least a portion of the second image data. Examples of the graphical effect may include a colouring effect or animation, or other types of graphical effect.

The second image data may comprises a view of an avatar of the user, or may comprise another representation of the user (e.g. based on the received first image data or newly received/captured image data).

If the second image data comprises a view of an avatar, the controller 320 may use the user's isolated anatomical feature elements to create the avatar. Alternatively, the controller 320 may use the user's anatomical feature type for each category of anatomical features to create the avatar.

In some embodiments, there is an instructions database (not shown) that stores a plurality of image transformations. In such embodiments, each image transformation comprises a number of transformation steps, with each transformation step corresponding to one category of anatomical features and comprising a respective image processing instruction for each anatomical feature type within that category. For example, when comparing such an example to the embodiment of FIG. 1, an image transformation could correspond to a selected makeup style. In other embodiments, the image transformation could correspond to a skin care routine, nail style, etc.

In such embodiments, the apparatus 30 may receive a selection of an image transformation, e.g. from a user input (not shown). Then, the image processor 340 may image process the second image data according to a first transformation step of the selected image transformation by carrying out the image processing instruction of the first transformation step that corresponds to the user's determined anatomical feature type for the category of anatomical features corresponding to the first transformation step. The display 350 can then display the image processed second image data according to the first transformation step.

The image processor 340 may image process image the second image data according to the other transformation steps of the selected image transformation in order; and the display 350 may display the image processed second image data for each transformation step.

The apparatus 30 may receive a selection of a transformation step, e.g. from a user input (not shown), and in response the controller 320 may control the display to display the image processed second image data according to the selected transformation step. Hence, the user may select a particular transformation step (corresponding to one of the step-by-step instructions discussed in relation to FIG. 1) or cycle through the transformation steps.

As discussed, the apparatus 30 may comprise a camera (not shown). Using the camera, the apparatus 30 may capture video images of the user and the display 350 may display the image processed second image data alongside the captured video images of the user.

Using the techniques discussed above, the image processing apparatus 30 according to this generalised embodiment may provide tutorial information to a user. However, embodiments of the invention are not limited in this way. The image processed second image data may be displayed for any desired purpose.

In some embodiments, the image processing apparatus 30 may carry out the steps shown in FIG. 10. These steps may be modified for other anatomical features or uses other than providing makeup tutorials.

The image processing apparatus 30 may be implemented a mobile device (e.g. smartphone or tablet). However, embodiments of the present invention are not limited in this way. The image processing apparatus 30 may be implemented on a PC (e.g. with a camera), TV, or other such device.

As another example, the image processing apparatus 30 may be implemented as a smart mirror, for example comprising a display that have a mirrored portion and a display portion, or a display that can be controlled to be a mirror or a display.

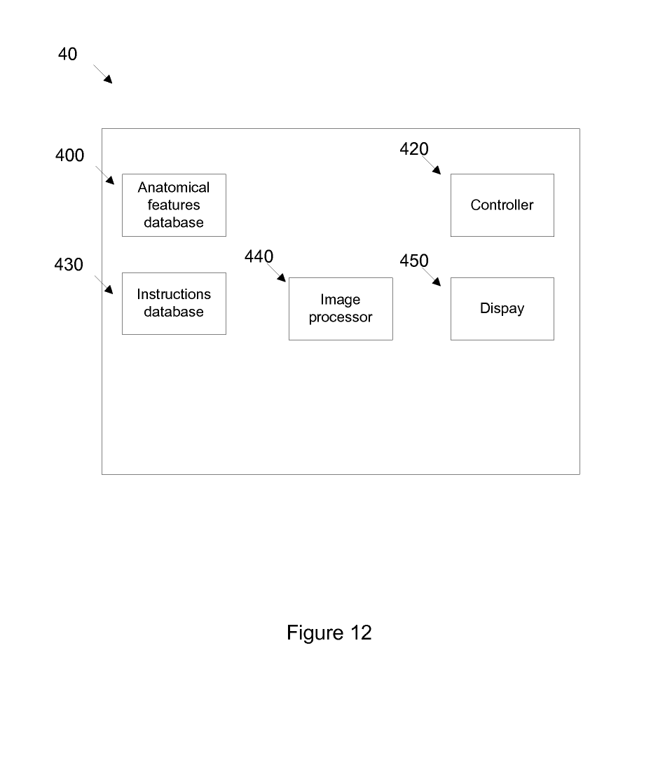

FIG. 12 shows a schematic diagram of an image processing apparatus 40 according to a third embodiment of the invention. In this embodiment there is an anatomical features database 400, a controller 420, an instructions database 430, an image processor 440, and a display 450.

The anatomical features database 400 comprises information on at least one category of anatomical features, wherein each category of anatomical features includes a number of anatomical feature types.

The instructions database 430 comprises a plurality of image processing instructions, each image processing instruction corresponding to one of the said anatomical feature types.

The image processor 440 is arranged to image process second image data representing the user by carrying out image processing instructions corresponding to the user's determined anatomical feature type for each category of anatomical features.

In this embodiment, first image data representing anatomical features of the user is received. The first image data may be received via a camera (not shown) or retrieved from a local or remote memory or file store. In this embodiment the first image data is video data received via a front facing camera (not shown).

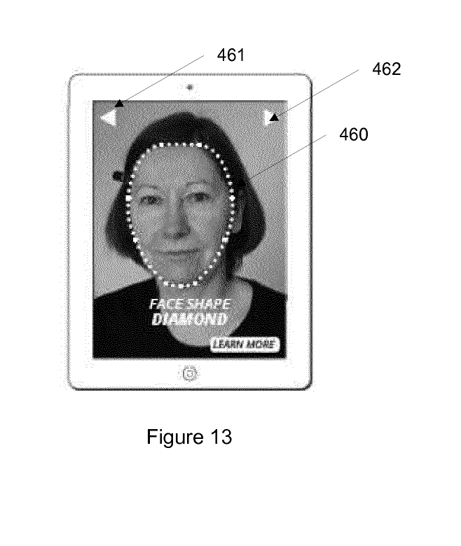

The image processor 440 processes the first image data to show a representation of one of the anatomical feature types within a first category of anatomical features overlaid on the first image data. For example, if the anatomical feature category “face shape” is considered in relation to the first image data being an image of the user's face, then the image processor 440 may determine the outline of the user's face and overlay a representation of a first anatomical feature type corresponding to “diamond” face shape as outline 460 shown in FIG. 13 (illustrated as a smartphone for convenience). The first image data may present a camera feed, and the user may (in this example) place their face in a position to correspond to the outline face shape 460.

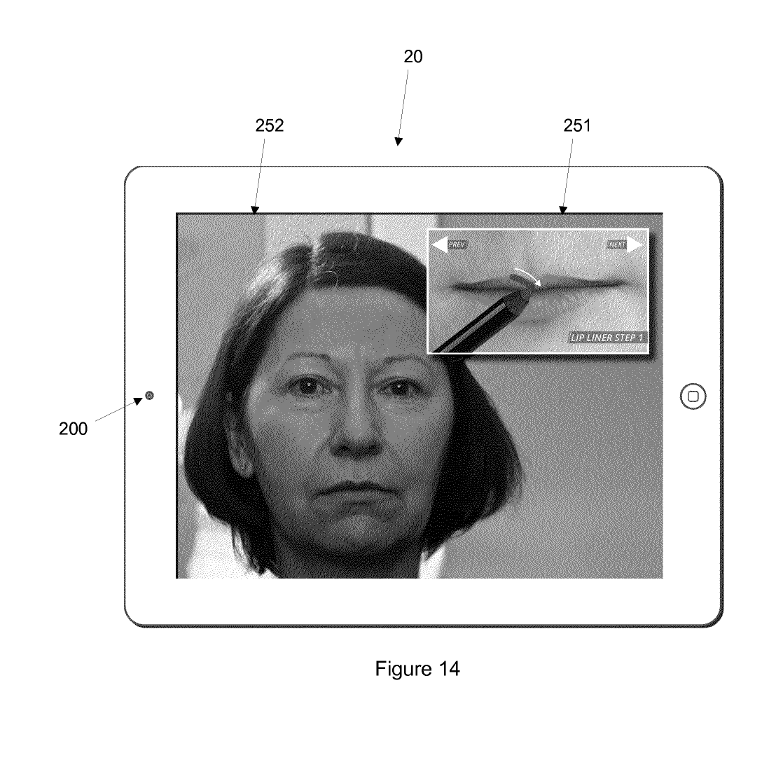

The image processing apparatus 40 may then receive a user input (via a user input) for scrolling between different anatomical feature types within the first category of anatomical features overlaid on the first image data. In the example of FIG. 14, this may be via the scroll buttons 461 and 462, though other user input arrangements could be used (e.g. swiping or otherwise). Hence, the user could scroll through the different stored face shapes (e.g. the same ones mentioned above in relation to FIG. 2a, though embodiments of the invention are not limited to this) until the user consider that the outline 460 matched their face shape.

When the user is satisfied that the anatomical feature types within the first category of anatomical features match their features for that category (e.g. when the outline 460 matches their face shape as shown in FIG. 13), the image processing apparatus 40 may receive user selection relating to the user's choice of their anatomical feature type for the first category of anatomical features. This could be via any suitable user input.

The image processing apparatus 40 can then repeat this process of 1) showing a representation of one of the anatomical feature types within one of the categories of anatomical features overlaid on the first image data, 2) enabling the user to scroll between different anatomical feature types within the category, and 3) receiving a user selection relating to the user's choice of their anatomical feature type for that category, for each of the other categories of anatomical features.

In a variation of the third embodiment, the image processing apparatus may comprise an anatomical feature processor (not shown) that is arranged to isolate anatomical feature elements of the user from within received first image data. In such an embodiment, the image processor 440 may processes the first image data to show a representation of one of the anatomical feature types within a first category of anatomical features overlaid on the first image data at a position corresponding to a corresponding isolated anatomical feature element of the user. In other words, for example, the anatomical feature processor may perform a face recognition step and determine the rough outline of the user's face, and the image processor 440 may process the first image data to show outline face shapes at a position corresponding to the user's facial outline. In a similar way, the anatomical feature processor may determine the location of the user's nose and this information may be used to enable the image processor 440 to determine where to place outlines of different nose shapes. Hence, in this embodiment, the image processor can detect the rough presence of the user's anatomical features (e.g. rough outline of the face), but does not need to accurately determine the user's anatomical feature type within each category.

The image processing apparatus 40 can then store a representation of the user as second image data, with the second image data being obtained based on the user's choice of their anatomical feature type for each category of anatomical features.

Then, image processing is carried out on second image data that represents the user by the image processor 440, with the image processing comprising carrying out a said image processing instruction corresponding to the user's determined anatomical feature type for a first category of the categories of anatomical features. The display 450 then displays the image processed second image data.

The third embodiment can be considered to be a generalised system when compared to the first embodiment. In such an embodiment, the anatomical features database 400 may, for example, store information relating to facial features of the user. In such an example, the anatomical features database 400 may store the same or similar information to that stored in the database of facial features 120 mentioned in relation to FIG. 1. Alternatively, the anatomical features database 400 may store different facial features. As an example, the features relevant to a skin care tutorial might well be different to those relating to a makeup tutorial.

In other examples, the anatomical features database 400 may store information on anatomical features relating to the hand and nails of the user. In other examples, the anatomical features database 400 may store information on other anatomical features of the user. In general, the anatomical features database 400 may store information on any anatomical features of the user that the system is designed to provide tailored image processing for.

Each image processing instruction comprises instructions to enable the image processor 440 to process the second image data for a desired effect. For example, the image processing instructions may comprise at least one of a graphical effect to be applied to at least a portion of the second image data. Examples of the graphical effect may include a colouring effect or animation, or other types of graphical effect.

The second image data may comprises a view of an avatar of the user, and the controller 420 may use the user's anatomical feature type for each category of anatomical features to create the avatar.

In some embodiments, there is an instructions database (not shown) that stores a plurality of image transformations. In such embodiments, each image transformation comprises a number of transformation steps, with each transformation step corresponding to one category of anatomical features and comprising a respective image processing instruction for each anatomical feature type within that category. For example, when comparing such an example to the embodiment of FIG. 1, an image transformation could correspond to a selected makeup style. In other embodiments, the image transformation could correspond to a skin care routine, nail style, etc.

In such embodiments, the apparatus 40 may receive a selection of an image transformation, e.g. from a user input (not shown). Then, the image processor 440 may image process the second image data according to a first transformation step of the selected image transformation by carrying out the image processing instruction of the first transformation step that corresponds to the user's determined anatomical feature type for the category of anatomical features corresponding to the first transformation step. The display 450 can then display the image processed second image data according to the first transformation step.

The image processor 440 may image process image the second image data according to the other transformation steps of the selected image transformation in order; and the display 450 may display the image processed second image data for each transformation step.

The apparatus 40 may receive a selection of a transformation step, e.g. from a user input (not shown), and in response the controller 420 may control the display to display the image processed second image data according to the selected transformation step. Hence, the user may select a particular transformation step (corresponding to one of the step-by-step instructions discussed in relation to FIG. 1) or cycle through the transformation steps.

As discussed, the apparatus 40 may comprise a camera (not shown). Using the camera, the apparatus 40 may capture video images of the user and the display 450 may display the image processed second image data alongside the captured video images of the user.

Using the techniques discussed above, the image processing apparatus 40 according to this generalised embodiment may provide tutorial information to a user. However, embodiments of the invention are not limited in this way. The image processed second image data may be displayed for any desired purpose.

A difference between the embodiment of FIG. 12 and the embodiment of FIG. 11, is the in the embodiment of FIG. 12, it is the user that picks their anatomical feature type within each anatomical feature category, rather than this being done by comparing the isolated anatomical feature elements with information in the anatomical features database to determine the user's anatomical feature type within each category of anatomical features.

The image processing apparatus 40 may be implemented a mobile device (e.g. smartphone or tablet). However, embodiments of the present invention are not limited in this way. The image processing apparatus 40 may be implemented on a PC (e.g. with a camera), TV, or other such device.

In embodiments in which there is a camera, a 2d of 3d camera may be used. 3d cameras allow depth scanning and used in conjunction with 2d scanning offer the ability to create a more accurately represented avatar of the end user.

Any of the above mentioned embodiments may provide a makeup tutorial system, by providing tailored makeup instructions to the user for each category of anatomical features (e.g. face shape, nose shape etc,) based on the user's particular set of anatomical feature types.

FIG. 14 shows an embodiment of a makeup tutorial system 20, in which the makeup instructions are provided in a window 251, with the rest of the screen display 252 used to show mirror functionality. In this embodiment, the makeup tutorial system 20 is a tablet with a front facing camera 200. In FIG. 14, the front facing camera 200 of the makeup system 20 is used to capture real-time video of the user, and the window 251 is used to display the makeup instructions. Hence, the user can apply the makeup as instructed and see the makeup applied to the avatar and the makeup applied to themselves on the same screen. Such a makeup tutorial system 20 could be used with any of the above mentioned embodiments.

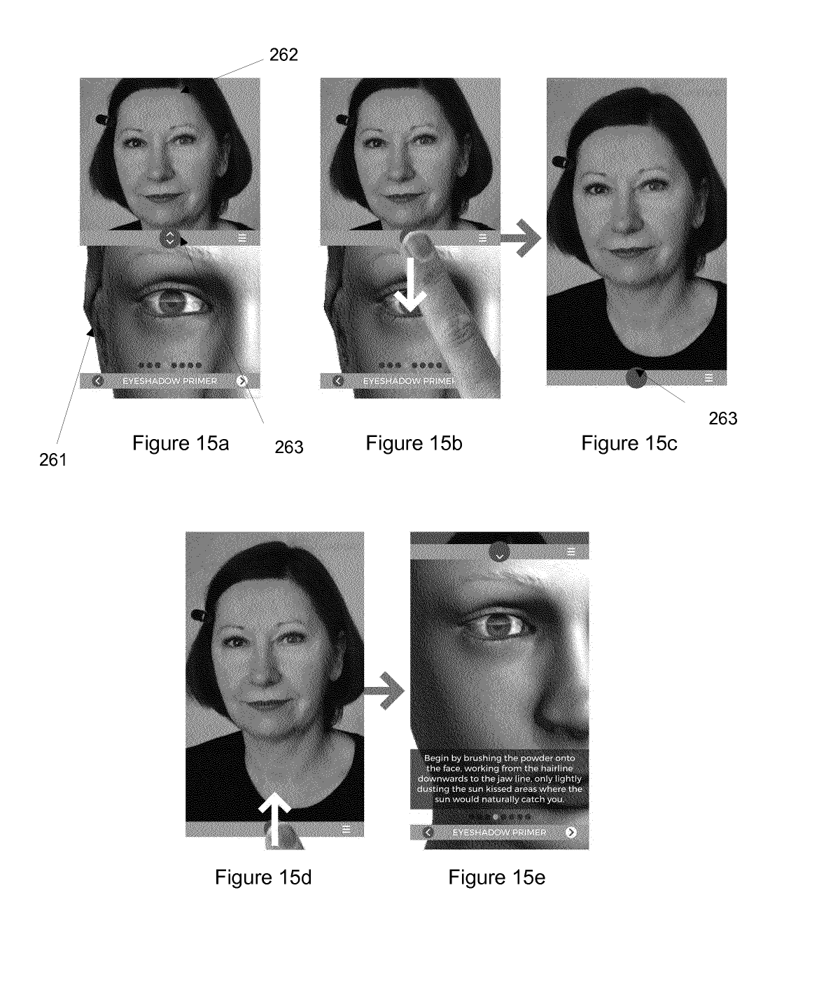

FIGS. 15a-15e show another alternative embodiment of a makeup tutorial system, in which the makeup instructions are showable in a makeup window 261, with mirror functionality being showable in a mirror window 262. In this embodiment, the makeup tutorial system is a smart phone, table or the like with a front facing camera (not shown). In FIGS. 15a-15e, the front facing camera is used to capture real-time video of the user which can be shown in the mirror window 262, and the makeup window 261 is used to display the makeup instructions. In this embodiment, there is a user interface element 263 (in this case an arrow button) that enables the user to swipe up or down to alter the view between a split mirror/make-up instructs view, a full screen makeup instructions view, or full screen mirror view. Hence, the user can apply the makeup as instructed and see the makeup applied to the avatar and the makeup applied to themselves on the same screen.

In more detail, FIG. 15a shows a split view in which the mirror window 262 and the makeup window 261 can up roughly half of the screen, with the user interface element 263 being centrally placed. In FIG. 15b, the user swipes the user interface element 263 downwards, and as a result the mirror window 262 is shown full screen in FIG. 15c.

In FIG. 15d, the mirror window 262 is shown full screen, and the user swipes the user interface element 263 upwards, and as a result the makeup window 261 is shown full screen in FIG. 15d. Of course, it will be appreciated that the user may choose to transition from mirror window 262 being shown full screen in FIG. 15d, back to a split view as shown in FIG. 15a. Furthermore, it will be appreciated that some embodiments may enable the split view showing the mirror window 262 and the makeup window 261 to show any desired proportions of the mirror window 262 and the makeup window 261 depending on the user's preference. Alternatively, it may be desired that the makeup tutorial system restricts the splits to certain fixed splits (e.g. full mirror view, full makeup view, and half-half).

It will be appreciated that the functionality discussed in relation to FIGS. 15a-15e could be modified in various ways. For example, the user interface element 263 is shown as being a button in which “upwards” and “downwards” swiping controls the split of the mirror view and the makeup view. However, in other cases (e.g. if the display is landscape rather than portrait), a “left/right” swiping action may be used. Of course, other embodiments could use pressing, dragging or any other common UI technique to control the split of the mirror view and the makeup view. In more general terms, the transition from the mirror view to the makeup view can be effected on receiving a user interaction from touch screen indicating a directionality (e.g. “upwards” or “downwards”) either towards or away from the region of the mirror view or region of the makeup view—e.g. with a swipe (or otherwise) towards the region of the mirror view indicating a transition to the makeup view and vice versa.

It will also be appreciated that the functionality discussed above in relation to FIGS. 15a-15e is generally applicable to a large number of difference use cases.

In general, embodiments of the invention can provide a computer-implemented method of processing an image of a user to provide a mirror view and an application view in a mobile device comprising a front facing camera and a touch screen display. Such methods can comprise receiving first image data of a user from the front facing camera of user; displaying the first image data of the user in a mirror window in a first region of the touch screen display, and simultaneously displaying application data of an application running on the mobile device in an application window in a second region of the touch screen display. On receipt of a user interaction from the touch screen indicating a directionality between the first region and the second region, the size of the mirror window and/or the application window can be changed. If the directionality represents a direction from the first region to the second region, the method comprises increasing the size of the mirror window and decreasing the size of the application window. If the directionality represents a direction from the second region to the first region, the method comprises increasing the size of the application window and decreasing the size of the mirror window.

The method of such embodiments can comprise displaying the mirror window in a full screen mode, and receiving a user interaction from the touch screen indicating a directionality representing a direction from the second region to the first region, and decreasing the size of the mirror window and showing the application window.

The method of such embodiments can comprise displaying the application window in a full screen mode, and receiving a user interaction from the touch screen indicating a directionality representing a direction from the first region to the second region, and decreasing the size of the application window and showing the mirror window.

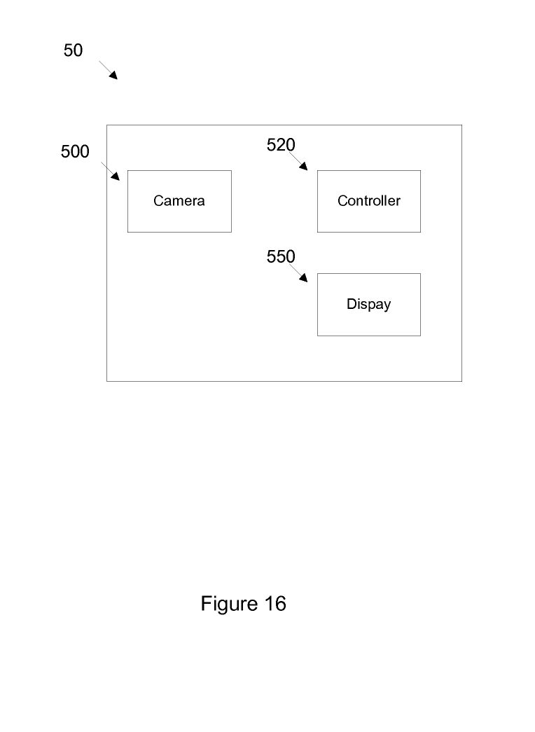

Embodiments, of the invention can also provide a mobile device 50 as shown in FIG. 16. This mobile device 500 comprises a front facing camera 500, a touch screen display 550 and a controller 520.

The front facing camera 500 is arranged to receive first video image data of a user from the front facing camera of user. The touch screen display 550 is arranged to display the first video image data of the user in a mirror window in a first region of the touch screen display, and simultaneously to display application data of an application running on the mobile device in an application window in a second region of the touch screen display.

The controller 520 is arranged to receive a user interaction from the touch screen indicating a directionality between the first region and the second region; wherein if the directionality represents a direction from the first region to the second region, the method comprises increasing the size of the mirror window and decreasing the size of the application window; and wherein if the directionality represents a direction from the second region to the first region, the method comprises increasing the size of the application window and decreasing the size of the mirror window. Such a mobile device 50 could be a smartphone, tablet or the like.

The “application” mentioned above could be any application or program (or other software that displays something to the use) running on the mobile device.

By “full screen mode”, it will be appreciated that this may refer to showing a screen mirror or an application without in what might be referred to as “normal” mode, i.e. with no split view or the like. As a result, it may be appreciated that a “full screen” view for an application may include (for example) certain OS display elements such as a battery life indicator, an indication of signal strength etc.

As discussed, embodiments of the invention can provide an image processing apparatus and/or a mobile device.

The image processing apparatus of embodiments of the invention may be implemented on a single computer device or multiple devices in communication. More generally, it will be appreciated that the hardware used by embodiments of the invention can take a number of different forms. For example, all the components of embodiments of the invention could be provided by a single device (e.g. a mobile device with a camera), or different components of could be provided on separate devices (e.g. a PC connected to an external camera). More generally, it will be appreciated that embodiments of the invention can provide a system that comprises one device or several devices in communication.

Embodiments of the invention can also provide a computer readable medium carrying computer readable code for controlling an image processing system (and/or a mobile device) to carry out the method of any one of the above mentioned embodiments.

Many further variations and modifications will suggest themselves to those versed in the art upon making reference to the foregoing illustrative embodiments, which are given by way of example only, and which are not intended to limit the scope of the invention, that being determined by the appended claims

1. A computer-implemented method of processing an image of a user, comprising:
storing an anatomical features database comprising information on a plurality of categories of anatomical features in a computer-readable memory, wherein each category of anatomical features includes a number of anatomical feature types;
receiving first image data of a user, the first image data representing anatomical features of the user;
processing the received first image data to show a representation of a first anatomical feature type within a first category of anatomical features overlaid on the first image data, receiving a user input for scrolling between different anatomical feature types within the first category of anatomical features overlaid on the first image data, receiving a user selection relating to the user's choice of their anatomical feature type for the first category of anatomical features, and repeating this step for each of the other categories of anatomical features;
storing a representation of the user as second image data in a computer-readable memory, wherein the second image data is obtained based on the user's choice of their anatomical feature type for each category of anatomical features;
storing an instructions database comprising a plurality of image processing instructions in a computer-readable memory, each image processing instruction corresponding to one of the said anatomical feature types;
image processing the second image data by carrying out a said image processing instruction corresponding to the user's determined anatomical feature type for one of the categories of anatomical features, displaying the image processed second image data, and repeating this step for all the categories of anatomical features in a sequence;
capturing video images of the user; and
displaying the image processed second image data alongside the captured video images of the user.

2. A method according to claim 1, further comprising:
processing the received first image data to isolate anatomical feature elements of the user from within the first image data;
processing the received first image data to show the representations of the anatomical feature types within the categories of anatomical features overlaid on the first image data at respective positions corresponding to corresponding isolated anatomical feature elements of the user.

3. A computer-implemented method of processing an image of a user, comprising:
storing an anatomical features database comprising information on at least one category of anatomical features in a computer-readable memory, wherein each category of anatomical features includes a number of anatomical feature types;
receiving first image data of a user, the first image data representing anatomical features of the user;
processing the received first image data to isolate anatomical feature elements of the user from within the first image data;
comparing the isolated anatomical feature elements with information in the anatomical features database to determine the user's anatomical feature type within each category of anatomical features;
storing a representation of the user as second image data in a computer-readable memory;
storing an instructions database comprising a plurality of image processing instructions in a computer-readable memory, each image processing instruction corresponding to one of the said anatomical feature types;
image processing the second image data by carrying out a said image processing instruction corresponding to the user's determined anatomical feature type for a first category of the categories of anatomical features; and
displaying the image processed second image data;
capturing video images of the user; and
displaying the image processed second image data alongside the captured video images of the user.

4. A method according to claim 3, further comprising:
image processing the second image by carrying out the image processing instructions corresponding to the user's determined anatomical feature types for all the categories of anatomical features.

5. A method according to claim 3, wherein the user's isolated anatomical feature elements are used to create an avatar of the user, and the second image data comprises a view of said avatar.

6. A method according to claim 3, wherein the user's anatomical feature type for each category of anatomical features is used to create an avatar of the user, and the second image data comprises a view of said avatar.

7. A method according to claim 3, wherein the second image data is displayed based on the first image data.

8. A method according to claim 1, further comprising storing a plurality of image transformations in the instructions database, each image transformation comprising a number of transformation steps, wherein each transformation step corresponds to one category of anatomical features and comprises a respective image processing instruction for each anatomical feature type within that category.

9. A method according to claim 8, further comprising:
receiving a user selection of an image transformation;
image processing the second image data according to a first transformation step of the selected image transformation by carrying out the image processing instruction of the first transformation step that corresponds to the user's determined anatomical feature type for the category of anatomical features corresponding to the first transformation step; and
displaying the image processed second image data according to the first transformation step.

10. A method according to claim 9, further comprising:
image processing the second image data according to the other transformation steps of the selected image transformation in order;
displaying the image processed second image data for each transformation step; and
receiving a user selection to select a said transformation step, and displaying the image processed second image data according to the selected transformation step.

11. (canceled)

12. A method according to claim 2, wherein processing the received first image data to isolate anatomical feature elements of the user from within the first image data comprises:
determining a plurality of control points within the first image data; and
comparing relative locations of control points with stored anatomical information.

13. A method according to claim 2, wherein the comparing the isolated anatomical feature elements with information in the anatomical features database to determine the user's anatomical feature type within each category of anatomical features comprises:
for each isolated anatomical feature element, determining user's anatomical feature type in the anatomical features database that is the best match.

14. A method according to claim 1, wherein each image processing instruction comprises a graphical effect to be applied to at least a portion of the second image data, wherein the graphical effect comprises at least one of a colouring effect or animation.

15. A method according to claim 1, wherein the displaying of the image processed second image data provides tutorial information to the user.

16. A method according to claim 1, wherein anatomical features are at least one of:
facial features of the user, and wherein the processing of the received first image to isolate anatomical feature elements of the user comprises performing facial recognition or
hand and nail features of the user, and wherein the processing of the received first image to isolate anatomical feature elements of the user comprises performing hand and nail recognition.

17-18. (canceled)

19. A method according to claim 1,
displaying the captured video images of the user in a mirror window in a first region of a touch screen display, and simultaneously displaying the image processed second image data in an application window in a second region of the touch screen display;
receiving a user interaction from the touch screen indicating a directionality between the first region and the second region;
wherein if the directionality represents a direction from the first region to the second region, the method comprises increasing the size of the mirror window and decreasing the size of the application window; and
wherein if the directionality represents a direction from the second region to the first region, the method comprises increasing the size of the application window and decreasing the size of the mirror window.

20. A computer readable medium carrying computer readable code for controlling an image processing system to carry out the method of claim 1.

21-22. (canceled)

23. A computer-implemented method of processing an image of a user to provide a mirror view and an application view in a mobile device comprising a front facing camera and a touch screen display, comprising:
receiving first video image data of a user from the front facing camera of user;
displaying the first video image data of the user in a mirror window in a first region of the touch screen display, and simultaneously displaying application data of an application running on the mobile device in an application window in a second region of the touch screen display;
receiving a user interaction from the touch screen indicating a directionality between the first region and the second region;
wherein if the directionality represents a direction from the first region to the second region, the method comprises increasing the size of the mirror window and decreasing the size of the application window; and
wherein if the directionality represents a direction from the second region to the first region, the method comprises increasing the size of the application window and decreasing the size of the mirror window.

24. A method according to claim 23, comprising:
displaying the mirror window in a full screen mode, and
receiving a user interaction from the touch screen indicating a directionality representing a direction from the second region to the first region, and decreasing the size of the mirror window and showing the application window.

25. A method according to claim 23, comprising:
displaying the application window in a full screen mode, and
receiving a user interaction from the touch screen indicating a directionality representing a direction from the first region to the second region, and decreasing the size of the application window and showing the mirror window.

26. (canceled)
